(19) United States
(12) Patent Application Publication
(10) Pub. No.: US 2006/0186638 A1
(43) Pub. Date: Aug. 24, 2006

(54) Exercise equipment support unit and method for mounting the same

(76) Inventor: David L. Varner, Marietta, GA (US)

Correspondence Address: SMITH, GAMBRELL & RUSSELL, LLP, 1230 PEACHTREE STREET, N.E., SUITE 3100, PROMENADE II, ATLANTA, GA, 30309-3592, US

(21) Appl. No.: 10/758,369

(22) Filed: Jan. 15, 2004

Related U.S. Application Data
(60) Provisional application No. 60/447,466, filed on Feb. 14, 2003.
(60) Provisional application No. 60/461,348, filed on Apr. 9, 2003.

(51) Int. Cl. B60D 1/04

(52) U.S. Cl. 280/506

(57) ABSTRACT

A support unit for attachment to a vehicle receiver hitch comprising (i) a mount shank receivable in an end of the receiver tube of a common receiver hitch; (ii) a device on said mount shank for applying tension or force between said mount shank and said receiver tube; and (iii) means for applying a force to said mount shank and said receiver hitch beyond said end of said receiver tube, whereby movement of said mount shank within said receiver tube is prevented.

### CROSS-REFERENCE TO RELATED APPLICATIONS

This application claims priority under 35 U.S.C.§119(e) to U.S. Ser. No. 60/447,466, filed Feb. 14, 2003, and which is incorporated herein by reference.

### BACKGROUND OF THE INVENTION

This invention relates generally to a vehicle-mounted exercise equipment support unit, and more particularly, it concerns a wobble-free, receiver hitch-mounted exercise equipment support unit, wherein the unit can be movably mounted relative to the vehicle for facilitating the placement and removal of exercise equipment thereon. The inventive hitch mount substantially eliminates the tendency of any mounted fitness equipment to move or wobble due to hitch mount shifting within a vehicle's hitch sleeve.

The present invention relates to a hitch receiver for a vehicle, and more particularly to a hitch receiver that minimizes free play while still being useful as an exercise equipment mount or unit.

Prior art hitches are designed to carry or tow objects behind a vehicle in motion. A common method of transporting such articles is by attaching the object to the vehicle using a receiver style hitch. Receiver style hitches mounted to a vehicle provide a strong connection and convenient use for such purposes as towing cargo and interconnecting the vehicle to carriers. Conventional receiver trailer hitches typically include a female receiver mounted to the vehicle which receives an insert having a corresponding shape such that the insert may be slid into the receiver. The receiver insert is removably attached to the receiver by a locking pin which passes through the receiver and the insert.

The fit between the two pieces must be loose enough to provide for their convenient engagement and disengagement, but tight enough to minimize vibration during transport or towing operations. These two competing objectives typically result in undesirable free play between the hitch receiver and the receiver insert.

An undesirable feature of prior art structures is the erratic movement caused by free play between the hitch receiver and the receiver insert. Such erratic motion has made prior art hitches unusable as mounts for exercise equipment.

The present invention is related to an exercise equipment support unit or mount which is attachable to a vehicle receiver-type hitch and used preferably only when the vehicle is in the parked position. Prior art hitch mounts are used when the vehicle is in motion, i.e., by pulling a trailer or the like, or for cargo-carrying. As discussed below all such prior art hitch devices are to facilitate movement of an article, trailer, bicycle, or the like, from one point to another.

More and more people are discovering the outdoors, and the various outdoor activities in which one can participate. Many outdoor activities require the use of various types of articles such as exercise equipment, sports equipment and the like. For example, people who enjoy skiing, and who own their own equipment, must usually transport their equipment to a suitable ski area. Similarly, people who enjoy bicycling in areas other than those in which they live, must usually transport their bicycle or bicycles to such areas on a vehicle.

In line with the growing fitness and outdoor trends which have developed, a number of prior art types of so-called support equipment has evolved which enables an individual to transport, on a vehicle, various articles desired to be used in an outdoor setting.

As an example, any number of prior art vehicle-mounted, article-carrying racks such as bicycle racks have been developed for enabling an individual to carry articles on almost any part of a vehicle. There are racks which are roof-mounted, front-mounted, and rear-mounted which enable an individual to carry articles, respectively, on a vehicle roof, front, or rear. There are also racks which are mountable in a truck bed to enable an individual to carry articles therein.

There are no known devices or units for mounting an exercise unit to a vehicle in order to make the exercise equipment portable and usable by an individual anywhere, at any time. The present invention may be used anytime the individual has access to a vehicle having a receiver-type hitch.

More and more people are becoming more attentive to their physical well-being. Gym memberships have been increasing, and exercise is widely regarded as an essential ingredient in cardiac care. While many acknowledge the need to exercise, busy schedules often make it difficult to go to a gymnasium. Accordingly, many miss the exercise that we need to stay fit.

Mobile or portable fitness centers are well-known. The prior art is replete with numerous vehicles for transporting displays and providing exhibition areas for products and performance. Examples include U.S. Pat. Nos. 4,958,874, 5,310,209, Re. 32,262, 4,689,924 and 5,280,985.

While these mobile expandable structures have been suggested for broadcasting field events, vacation use and merchandising, there is a limited availability of mobile units in the marketplace for providing convenient access to gym equipment for busy individuals. One such unit is essentially a gym on wheels. This device is a truck with a small amount of workout equipment. Another such device provides mobile fitness centers which include one or more pieces of training equipment, for example, weights, stationary bicycles or rowing machines. These fitness centers include a trailer having top, bottom, front and back portions along with a pair of longitudinal sides. They further include at least one movable panel which can be adjusted from a first position forming part of one of the longitudinal sides, to a second position which forms an extended floor for providing more surface for exercise equipment and training. The trailers can open up and become much larger than conventional portable U-Haul type units, having floor space over 350 square feet which can provide room for a wide variety of exercise equipment. Another mobile fitness center is a trailer provided with a hinged side panel having one or more jacks for supporting the panel in the open position so as to provide a firmly supported extended floor. The extended floor area can also be protected by a removable roof cover supported by a pole support structure.

The present invention relates to the field of exercise and training equipment, and more particularly to a portable apparatus which is adapted to support a variety of accessory component attachments so that a user can warm up, workout, and/or train in a vast array of sports and activities.

The art is crowded with exercise equipment for all types of sports and activities. To a large extent, the exercise equipment in the related art is directed to weight lifting or body building, wherein various devices are provided to exercise and build different muscles of the body. In general, exercise equipment falls into two categories, namely, fixed, permanently installed equipment and collapsible equipment. Examples of permanently installed equipment can be found in most health and fitness clubs, as well as in the home gym industry. For example, fitness clubs usually provide a collection of different machines, arranged in one or more large rooms, wherein each machine is dedicated to exercising a particular muscle group. A home gym, on the other hand, usually combines a number of devices into one apparatus wherein several work stations are provided about a fixed frame structure, wherein each sports station usually includes equipment for exercising one or more muscles of the body.

While fitness clubs provide a wide variety of machines for anaerobic as well as aerobic workouts, this type of equipment tends to be extremely heavy and immobile. Further, many people, particularly, younger individuals, do not stay in the same area for an extended period of time. Additionally, a fair percentage of today's work force travel quite frequently, thereby making it difficult to maintain a routine of exercise at a fitness club. In many instances, people who join fitness clubs find that they do not use them after a few months, as it becomes too inconvenient to fit regular visits to the fitness club into one's busy schedule. In other instances, people move to another town and have to forfeit their membership in a fitness club before it expires.

Other health conscious individuals find the means for staying in shape with the use of a home gym apparatus. As with fitness clubs, there is a large number of home gym machines available on the market. These exercise units provide similar ranges of exercises to those found in fitness clubs. However, much like the equipment in fitness clubs, a home gym tends to be very bulky, heavy and generally immobile. This type of equipment can be found in U.S. Pat. Nos. 4,072,309; 4,541,627; and 4,023,715. A further limitation of a home gym is the difficulty in transporting the apparatus to another location should the owner of the equipment need to change residences. Unfortunately, the cost to disassemble, move, and then reassemble a home gym at a new location can often cost as much or more than the original purchase of the equipment. Furthermore, most individuals do not have sufficient space in their home to accommodate a home gym apparatus.

Portable, collapsible exercise equipment is increasingly popular due to the busy lifestyles of today's health conscious society. Examples of this type of equipment are seen on extended length television commercial advertisements and include stair-stepper machines, rowing machines, sit-up devices, and body building devices. For the most part, this equipment is designed to collapse to a more compact configuration so that it can be stored under a bed or in a closet, thus appealing to those with limited space in their homes. And, while portable, collapsible equipment is available for a wide range of activities, and not limited to body building, each item of equipment tends to be limited to the specific activity to which it was designed.

A further problem associated with both permanently installed more industrial-type exercise equipment and portable exercise equipment is the limited range of exercises and activities which can be performed on the equipment. As mentioned above, most exercise equipment is geared towards exercising and building muscles on one or more areas of the body. A smaller percentage of exercise and training equipment is geared to training in specific sports, such as baseball, football, or golf. The various apparatus known for these particular uses is generally limited to one sport or activity. Thus, a person desiring to train in a variety of sports, including weight lifting and body building, must purchase separate equipment for each activity. For most people, this is impractical due to the cost and limited availability of space to accommodate several items of equipment.

Prior art article carrying racks are not useable for mounting exercise equipment. The known racks are limited in utility for a number of reasons which include that such are not simple to use and all such racks will not adequately support exercise equipment and will wobble when attached to a vehicle.

U.S. Pat. No. 5,181,822 describes an articulated support rack for vehicles which includes a base member for releasably attaching the rack to a vehicle, a pivotally mounted frame on the base member, a support arm on the frame extending horizontally away therefrom which remains substantially horizontal as the frame pivots, and a locking assembly attached to the base member which includes a pair of lock plates for releasably engaging the frame members and a foot-actuatable lever for selectively disengaging the lock plates from the frame members. The locking assembly is located below the bumper top edge so that an individual may actuate it with a foot. Such a rack would not be suitable for mounting exercise equipment because among other reasons in order to disengage the lock plates from the frame members, an individual must first access the above-mentioned lever which is below the bumper's top edge. This is not too difficult when the rack is not carrying a load. However, when the rack is loaded down, even when carrying a bicycle, an individual wishing to release the rack from its upright position must negotiate past the bicycle to reach the lever which may be cumbersome and awkward.

Another problem encountered by vehicle-mounted racks, and one which is not adequately addressed by the prior art, is the tendency of such racks to wobble when used on a vehicle. More to the point, certain types of racks are mountable on a vehicle by using a currently in-place hitch or hitch sleeve. Such sleeves are usually mounted on the rear part of a vehicle, below the bumper, and a majority of the hitch sleeves are tubular and have a square cross-section for accommodating various types hitch mounts such as ones which enable a vehicle to pull a boat trailer, camping trailer and the like. One problem encountered by article-carrying racks and by the above-mentioned trailers, is the tendency of the racks to wobble due, in part, to the fact that article-carrying racks are not grounded, but rather are above the ground for carrying a load substantially above the rear bumper. Any tendency of the rack's hitch mount to shift or move laterally within the vehicle's hitch or hitch sleeve is exaggerated by the rack, resulting in an undesirable wobbling condition which creates objectionable noise. This condition is undesirable for a number of reasons, not the least of which are safety concerns. Additionally, a shifting rack subjects a vehicle's hitch or hitch sleeve to stresses which may, after a while, result in fatigue and failure. Needless to say, there are simply numerous problems associated with the above-described wobbling situation which renders prior art carrying racks unsuitable for use as an exercise equipment support.

One prior art solution is to construct a hitch mount which wedges interiorly of the hitch sleeve. The solutions proposed thus far, while reducing somewhat the wobble problem, fall short of providing a complete and satisfactory solution. U.S. Pat. No. 5,423,566 discloses an insert tube which includes a wedge-shaped section which may be displaced in two directions to engage the upper and lower inside surfaces of the hitch sleeve. The insert tube leaves unencumbered, the internal sides of the hitch sleeve which, in turn, increases the possibility that the rack will shift or become laterally displaced and thereby wobble its load. Such an arrangement would not be useable as an exercise equipment support.

Accordingly, a need exists for a vehicle-mounted exercise equipment unit which is simple and easy to use, and which enables an individual to mount exercise equipment to a vehicle hitch.

Further, a need exists for a hitch mount which is easy to insert into a conventional receiver-type hitch, and which substantially reduces the tendency to wobble.

With the above problems in mind, it is a general object of the invention to provide an exercise equipment unit mount which is safe and simple to operate.

It is another object of the invention to provide a mount for an exercise equipment unit with a hitch mount that greatly reduces the tendency to wobble when mounted on a vehicle thereby providing a exercise equipment unit mount which is useable and safe, and one which reduces the stresses encountered by the receiver hitch and is quiet in use.

These and additional objects and advantages of the present invention will be more readily understood after a consideration of the drawings and the detailed description of the preferred embodiments.

### SUMMARY OF THE INVENTION

The present invention achieves these and other objects in the form of a receiver hitch mounted, wobble-resistant, exercise equipment unit mount which is easily mounted and removed for use by the individual when the vehicle is in a parked or stationary position.

According to one feature of the invention, the exercise equipment unit mount includes a hitch mount which is insertable into a vehicle's receiver hitch and adapted for engaging the hitch for reducing the tendency to wobble.

According to another feature of the invention, a wobble-reducing, exercise equipment unit mount is adapted for insertion into a vehicle-mounted hitch sleeve which is generally square in transverse cross-section. The exercise unit mount contains a stabilizer (e.g., tensioner) positioned between the end which is inserted into the receiver hitch and the end which supports the exercise unit. The stabilizer may be of any known means and preferably is a screw-type tensioner which will abut against the vehicle receiver hitch. Advantageously, the end of the exercise unit support which is inserted into the receiver hitch has a locking mechanism which will prevent any unwanted removal of the exercise unit mount from the receiver hitch. Advantageously such locking member is a pin inserted through the side of the receiver hitch and through the exercise unit mount. Preferably the pin has a grip end which contains a magnetized portion to facilitate ease of insertion, locking, and withdrawal of the pin without the use of a cotter key or like device.

A preferred embodiment of the support unit will support any exercise equipment including devices for strength, sports, martial arts, and the like training. Advantageously the support unit forms an angle with the horizontal plane of the receiver hitch, or parallel with the surface upon which the vehicle rests, of from about 90° to about 30°. Preferably such angle is from about 50° to about 80°.

The exercise equipment support unit of the present invention does not require any alteration to existing receiver hitches. It is known that all receiver hitches are not uniform, and that the holes for insertion of locking pins are not a uniform distance from the end of the receiver hitch tube. This renders prior art receiver hitch attachments unuseful as exercise equipment support units since it is not possible to prevent prior art units from moving within the receiver hitch. The present invention is preferably designed (e.g., an adjustable engagement member as in a tensioning screw supported by a base block) so as to be suited for universal use with a wide variety of receiver hitch types. Also, while the present invention includes “reversed” embodiments wherein the stabilizing means is supported on the receiver hitch and is adjustable for contact with an insert of the hitch mount, a preferred embodiment is the reverse of this, as it is preferred to provide the stabilizing means on the hitch mount for engagement with a conventional hitch receiver.

In an embodiment of the invention, the hole in the insert portion of the support unit, which is inserted into the receiver hitch to form a pathway for the locking pin, is not circular, but a teardrop, oval, or like shape. Such shape applies greater force on the pin resulting in greater stability to the support unit when the present invention applies force (e.g., inward or outward tensioning/compression forces generated) directing the support unit away from the receiver hitch or farther into the receiver hitch.

As shown in the drawings the various embodiments of the invention include the use of a block, one end of which attached to the support unit and having a threaded hole through the other end through which a screw, bolt or the like is threaded. The bolt or screw engager is then tightened into contact with the end face or flange of the receiver hitch. Preferably two such threaded blocks are used, one on each side. This will ensure that there is no side to side motion, nor up and down motion, between the support unit and the receiver hitch when using exercise equipment attached to the support unit.

The exercise equipment may be attached to the support unit in any known manner. Preferably the exercise equipment slides into the end of the support unit opposite the end which is inserted into the receiver hitch and is securely attached by use of pins, screws, or the like.

Additional embodiments shown in the drawings include a right angle plate fixedly attached to the support unit and having holes drilled in the end or ends thereof which overlap the receiver hitch. The holes are threaded and bolts or screws are used to contact the receiver hitch.

A further embodiment includes the use of a single block attached at one end to the support unit and having a threaded hole at the other end for receiving a screw, bolt or the like through the threaded portion. Tightening the screw or bolt contacts the receiver hitch end and exerts a force on the support unit away from the receiver hitch. As previously stated this force in conjunction with the locking pin inserted through the receiver hitch and support unit stabilizes the support unit.

A further embodiment includes a block fixedly attached to the support unit wherein the other end of the block extends over the receiver hitch and has a threaded hole for use of a screw, bolt or the like which, when tightened, exerts force on the receiver hitch, stabilizing the receiver hitch in the support unit.

Additional embodiments include, for example, claw-style, lever-style, cam-style, and threaded-collar-style. As shown in the drawings in the lever-style the lever is positioned within the support unit tube which is inserted into the receiver hitch and has a slot for the lever to extend beyond or above the slot and contact the receiver hitch interior, thereby stabilizing the support unit.

The above discussion and drawings are not meant to be exhaustive, but only to be representative of some of the embodiments of the present invention. As previously stated, the present invention is a support unit for exercise equipment which is mountable to a receiver hitch of a vehicle, whereby the support unit is stabilized such that the exercise equipment is easily usable without undue motion between the support unit and the receiver hitch. As used herein vehicles includes golf carts and the like. The exercise equipment is suitable for strengthening, conditioning, rehabilitating, performing or practicing a golf swing, a baseball swing, or the like and would be advantageously used prior to beginning a round of golf or playing a baseball or tennis game. The present invention is usable any time the vehicle is stationary and can be used outside, or in a garage, carport or the like. The support unit is easily detachable for storage in a vehicle, garage, or the like. The present invention may be used with any fitness/exercise equipment which requires stabilization for use to exercise for fitness, health, rehabilitation, sports warm-up, practice, physical therapy or the like. Such devices include but are not limited to exercise devices such as golf, baseball, and the like practice devices, warm-up devices, rowing machines, stationary bikes, sit-up racks and the like.

The support unit advantageously has a rubberized coating in order to further quieten and protect the device. The screw, bolt or the like used advantageously has a plastic knob and/or soft knob in order to facilitate ease of use.

### BRIEF DESCRIPTION OF THE DRAWINGS

FIG. 1 shows a schematic illustration of the exercise equipment support unit of the present invention supporting exercise (releasable/attachable weight lifting equipment) relative to a parked vehicle.

FIG. 1A shows a schematic illustration of the exercise equipment support unit of the present invention supporting exercise (releasable/attachable stationary bicycle device) relative to a parked vehicle.

FIG. 1B shows a schematic illustration of the exercise equipment support unit of the present invention supporting exercise equipment (unitary support unit and stationary bicycle device) relative to a parked vehicle.

FIG. 1C shows a prior art view of a prior art trailer hitch, insert and locking pin combination with high wobble potential.

FIG. 1D shows a view taken along cross-section line 1D-1D showing a locking pin with high wobble potential.

FIG. 1E shows a schematic view of an insert having been adjusted with the stabilization means of the present invention to limit the degree of freedom of movement through a flush surface-to-surface contact arrangement.

FIG. 1F shows a view similar to that of FIG. 1E but with a multiple side surface-to-surface flush arrangement between the exterior walls of the insert and interior walls of the hitch mount.

FIG. 1G shows a side view along the length of the insert with the insert being in a stabilizing multi-edge binding arrangement relative to the receiver hitch interior.

FIG. 1H shows a side view similar to FIG. 1D embodiment but with the inclusion of the stabilizing means of the present invention which results in the locking pin being in surface contact with an edge of the receiving apertures in the receiver hitch by way of an outward pulling force on the insert relative to the station any receiver hitch, with withdrawal being precluded by the locking means.

FIGS. 1I and 1J show a side and a top plan view of an embodiment of the invention featuring stabilization means designed to both form an edge contact relationship and a locking pin tensioning relationship.

FIGS. 2A and 2B show a side view and an end elevational with an engagement device designed to achieve a multi-wall, surface-to-surface stabilization arrangement.

FIG. 3A shows a top plan view and FIG. 3B a front elevational view showing a hitch mount with an engagement device designed to work on a corner of the receiving hitch to achieve a multi-wall surface-to-surface contact arrangement at two different locations along the axis of elongation of the receiver hitch.

FIGS. 3C and 3D show an alternate embodiment featuring a releasable (spring biased bearing catch) base block pin which receives a threaded shaft with twist handle knob for engagement with the hitch mount which can be mounted centrally on the upper surface of the insert.

FIG. 4A shows a side view of an alternate embodiment of the hitch mount of the present invention featuring an engagement device with a fixed base and adjustable engager.

FIG. 4B shows a view of a tear shaped aperture in the insert holes through which the hitch-to-insert locking member extends through.

FIG. 5A shows an alternate embodiment of a hitch mount with engagement device, with FIG. 5B showing a non circular insert locking device aperture.

FIG. 6 shows an alternate embodiment of the present invention featuring an internally positioned engager with adjustment device.

FIG. 7 shows a side view of a coupled hitch receiver with the hitch mount engagement deice including a threaded collar member.

FIG. 8A and 8B show an alternate embodiment of a hitch mount with engagement device featuring a cam device with pivot base.

FIG. 9 shows a schematic view of the present invention mounted on a golf cart vehicle.

FIG. 9A shows the exercise equipment support with support exercise equipment base for use in supporting golf swing exercise equipment.

FIGS. 10A, 10B, and 10C show an alternate embodiment of the hitch mount with engagement means featuring an internal pivoting lever as the engager and threaded knob adjustment means.

FIG. 10D illustrates as additional cam (overcenter) engagement means in the form of a tensioning device that is hand adjusted.

FIGS. 11A and 11B illustrate an alternate embodiment of the present invention wherein the engager extends internally through the insert for contact with the receiver hitch interior.

FIG. 12 shows an embodiment similar to FIG. 4A, but with the base block secured to a gusset plate of the attachment base.

FIGS. 13A and 13B illustrate an additional embodiment of the hitch mount for removing free clearance between opposing insert and receiver hitch surfaces.

FIG. 14A shows a side elevational view of the support unit of the present invention featuring a base unit with insert for receipt by a receiver hitch.

FIG. 14B shows a front (insert) end elevational view of that which is shown in 14A.

FIG. 15 illustrates an alternate embodiment of the exercise equipment support unit for the present invention in the form of a swing plane adjustable trailer hitch base particularly suited for exercise equipment support.

FIG. 16 shows a side elevation view of an alternate embodiment of a swing plane adjustable trailer hitch base for exercise equipment.

FIG. 16A shows a link member utilized in the embodiment of FIG. 16.

### DETAILED DESCRIPTION OF PREFERRED EMBODIMENTS OF THE INVENTION

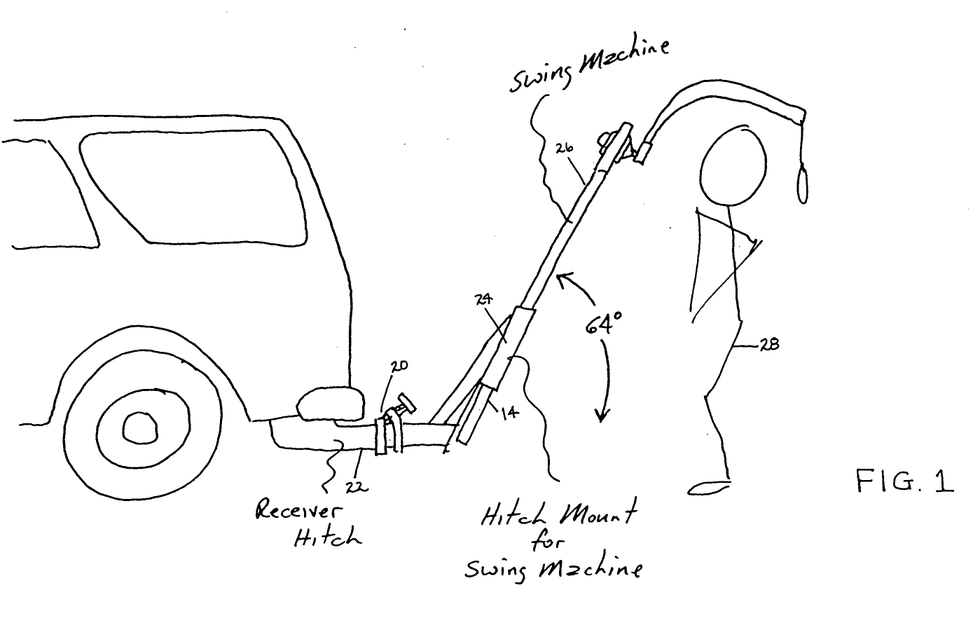

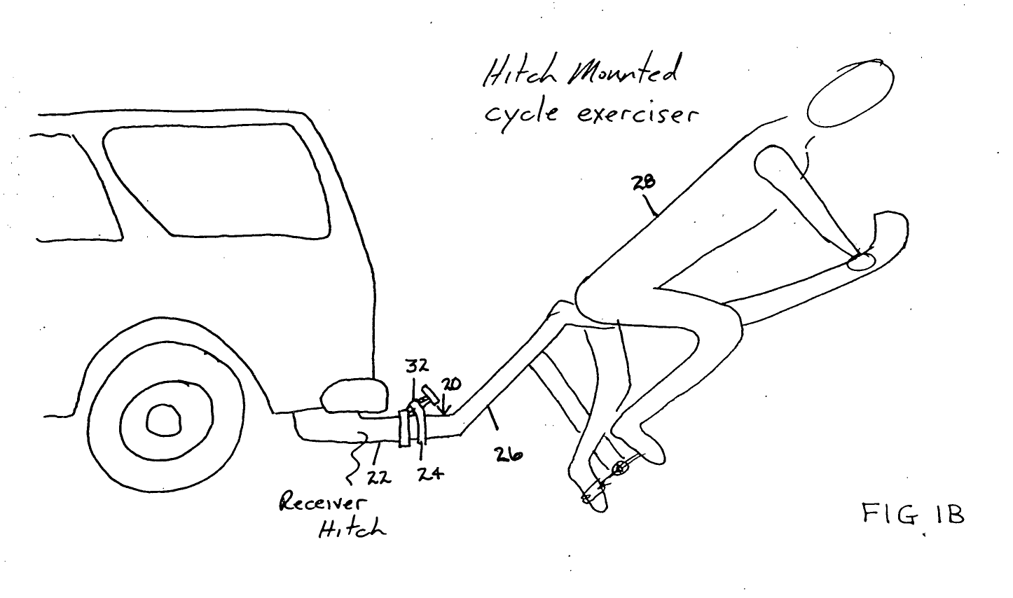

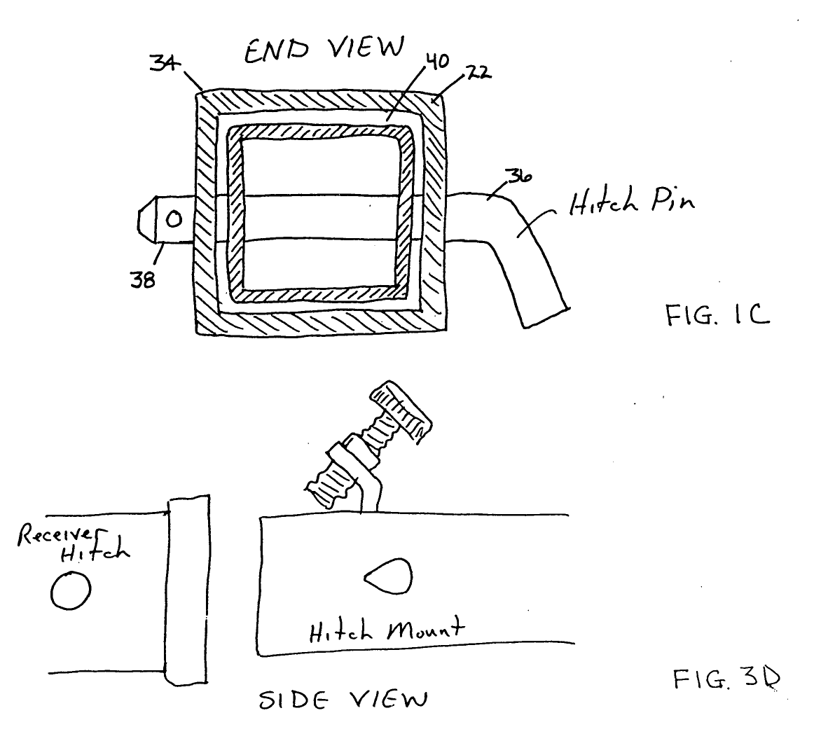

FIG. 1 shows a schematic view of the exercise equipment support unit 20 of the present invention received by the receiver hitch 22 of vehicle V (preferably stationary) which provides attachment support via attachment base 24 for attachable exercise equipment 26 as in the butterfly weight lifting device being utilized by user 28. Attachment base 24 is preferably sloped at angle “A” to facilitate a proper equipment 26/user 28 interface. As an example, a 60° angle for angle A is well suited for the type of exercise equipment shown in FIG. 1A.

FIG. 1A illustrates an alternate embodiment of the present invention featuring exercise equipment support unit 20 received by receiver hitch 22 and supporting exercise equipment 26. In the embodiment shown in FIG. 1A, support unit 20 includes attachment base 24 which receives (e.g., a releasable, stable attachment arrangement as in a multiple set of threaded bolt and nut combinations) an insert or reception piece which provides connection means between the attachment base and exercise equipment. Further, an adjustable attachment base 24 (as in the below described examples) and/or an adapter (not shown) or a set of different configured attachment base devices can be utilized to alter the resultant position of the exercise equipment. For example, baseball and tennis equipment apparatus often are preferably positioned with the main frame structure at a 90° or upright position while golf equipment is preferable in a 50° to 70° range relative to a horizontal plane and thus positioned further outward away from the vehicle relative to the 90° upright position so as to form an obtuse angle between the upper exposed surfaces of the insert 30 and attachment base 24.

FIG. 1B illustrates an alternate embodiment of the present invention featuring an exercise equipment support unit 20 which is comprised of a self-contained or integrated exercise equipment 26 and attachment base 24 combination supported by the vehicle receiver hitch, as in a unitary (e.g., welded) monolithic structure for main support component of the exercise equipment. As seen the attachment base is supported by a connection device 22 as in the insert (e.g., a male member) 30 which is shown extending partially within receiver hitch 22. Connection device 30 is preferably in the form of a beam, or the like, dimensioned for a telescoping arrangement relative to the receiver hitch as in a smaller cross-sectioned insert which is dimensional for telescopic extension into the interior of a receiver hitch, although alternate embodiments of the present invention are also contemplated as in an insert embodiment wherein the insert extends over and about a male receiver hitch compound (again would have the play or wobble problem do to the need to enable an operator to slide one relative to the other without undue binding or friction (which can be particularly problematic when dealing with insertion of heavier equipment.))

In view of the need to provide a stable base for proper functioning of supported equipment, as in the exercise equipment described herein and since wobbling can have a highly detrimental effect on equipment performance (e.g., a stable platform is required in exercise equipment as smoothness in operation and proper and maintained user-equipment position are important facets of any workout equipment) the present invention includes a hitch mount that includes stabilization or anti-wobble means.

FIG. 1C illustrates a conventional receiver hitch (22) insert combination 34 with engaged locking pin 36 designed to preclude a telescopic sliding out of the insert during vehicle movement. Locking spring clip 38 is similarly provided at the end of pin 36 to prevent inadvertent separation of the pin during vehicle operation. As seen from FIG. 1C (in exaggerated fashion to facilitate appreciation) there is a clearance space 40 (or potential clearance space depending upon the final resting position of the insert within hitch 22.) With this clearance space, there is introduced wobble potential both along axes X and Y. In addition, there is potential wobble generation along the Z axis as depicted in FIG. 1D, as there is also locking pin clearance space 42 require/desired to facilitate insertion and removal of the locking pin.

FIG. 1E illustrates (schematically—locking pin insert not shown) a wall surface of the insert having been shifted and fixed in surface-to-surface contact (represented by thickened line 44) with an interior surface of hitch 22.

FIG. 1F shows an alternate resultant effect of an embodiment of the stabilization means of the present invention which works to place two adjacent (about common corner edge 45) exterior side walls 46 and 48 into direct contact with the opposing interior hitch wall surfaces 50 and 52.

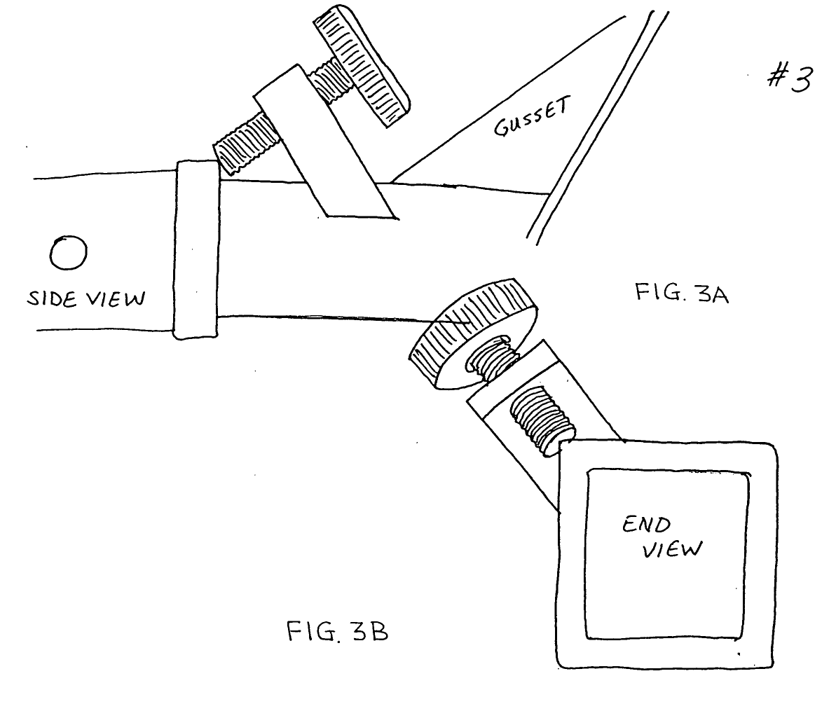

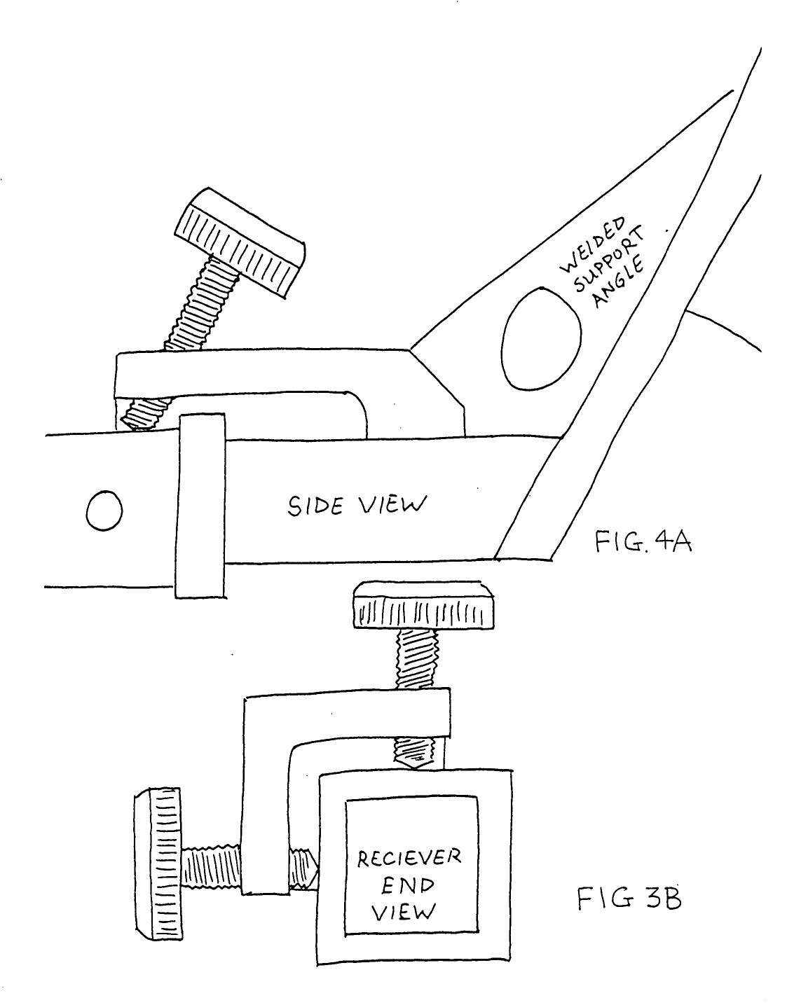

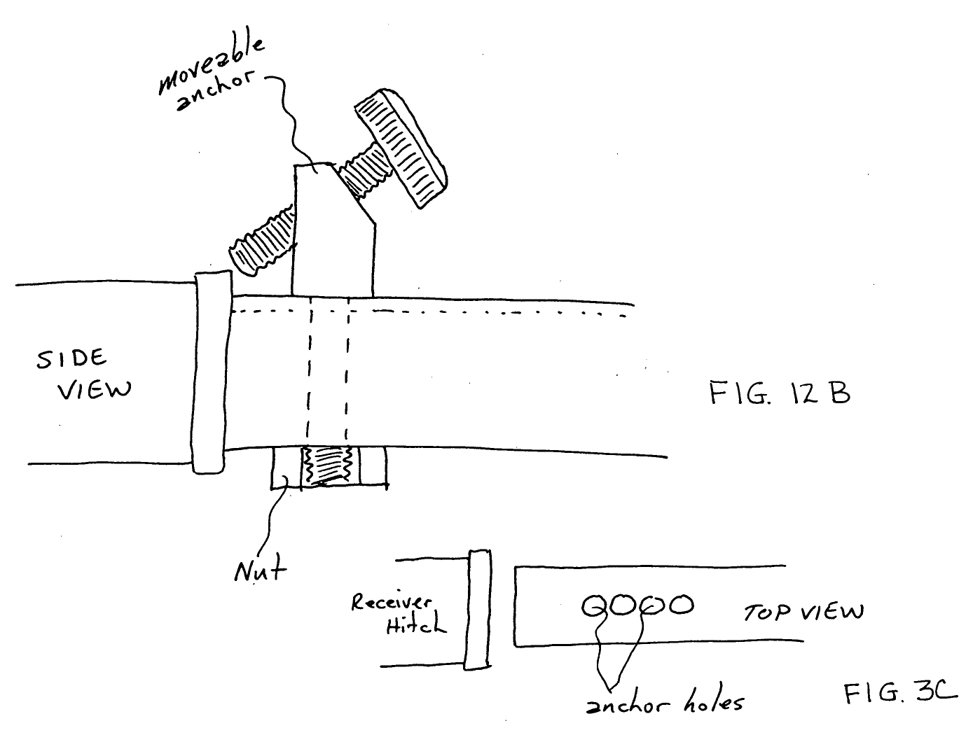

FIG. 1G shows an alternate stabilization arrangement provided by engagement device or stabilization means described below, wherein insert beam 30 is subjected to a rotation force (which force is retained so as to place the insert in a stabilizing state as opposed to a non-stable gravity only arrangement wherein wobble potential is still possible as in an exerciser's movement overcoming a gravity based contact). As seen from FIG. 1G, the rotation (R) imposed by the securement means leads to edge-to-wall surface contacts as in the illustrated (i) interior insert edge 54—to receiver wall surface 56 contact combination 58 and (ii) edge 62 of the open end of the receiver 60 edge 62 to insert wall surface 64 as represented by contact combination 66. While FIG. 1G shows a rotation limited to the central axis of locking pin 36, various other imposed rotation forces are also featured under the present invention as can be seen, for example, in the below described FIG. 3B arrangement wherein a diagonal adjustment is imposed due to the stabilizing force being imposed at one corner of the enlarged receiver hitch flange 68.

FIG. 1H illustrates engagement device 32 generating a drawing out generating force to place the insert in tension, which in turn places the locking pin aperture edge of insert 30 in compression contact with a portion 73 of the exterior surface of locking pin 36 as represented by thickened contact combination line 74. Since the receiver hitch provides a stable, fixed (e.g., preferably a parked vehicle with emergency brake) platform as represented by the “fixed” dash-line representation 76, the insert's opposite apertures edges (spaced along X-axis) are compressed against the surface of pin 36 as it abuts the corresponding X-axis spaced apertures provided in receiver hitch 22. To further enhance the stabilization state relative to at least the Y and Z axes, the locking pin reception aperture(s) (preferably each insert aperture from the standpoint of force symmetry) are preferably formed in a tear drop shape (e.g., generally circular region coupled with an outward converging region extending radially out from the location represented by an extension for the circle defining the circular region). The converging or tapered regions of the two tear drop configured pin apertures each present two opposing, generally planar contact surfaces 73′ and 73″ as shown in FIG. 1H. Preferably the elongation direction of the converging portions extend parallel with the axis of elongation of the trailer hitch, although alternate extension directions are also contemplated as in one conforming to the major resultant force direction imposed by the stabilizer (e.g., combination of a drawing out and pushing down or up combination) in which case an orientation as represented in FIG. 4B may be better suited as better conforming to a resultant force direction imposed by the stabilizing means of the present invention.

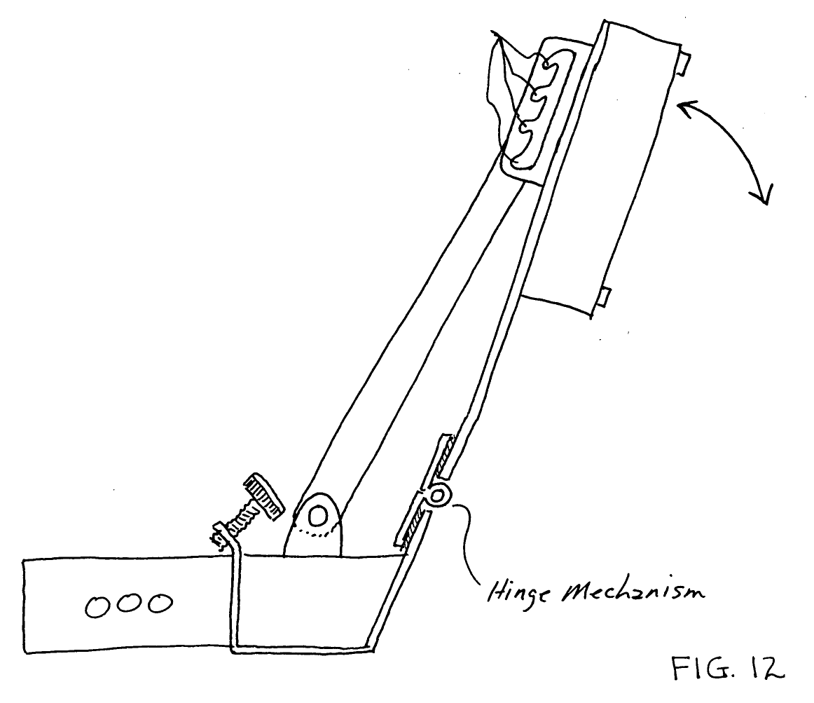

FIG. 1I illustrates, in side view, a first embodiment of exercise equipment support mount 20 received by a vehicle (e.g., an SUV although numerous other vehicle types are featured under the present invention as in, non-SUVs, golf carts, ATVs etc.) receiver hitch with pin reception holes 23 (one of two shown). Attachment base 24 extends away from end 25 of insert 30 and preferably includes corner gusset 76 for providing an increased structural rigidity for an attachable exercise device (not shown in FIG. 1I). As shown in the side view of FIG. 11 and the top plan view of FIG. 1J, the engagement device or stabilizer comprises a pair of base blocks 78, 80 which are oriented in oblique fashion (sloping upward from the horizontal at angle θ of, for example, 45°±15), Base Blocks 78, 80 also have back wall surfaces that are longer than the corresponding front wall surfaces extending parallel therewith. Accordingly, each back wall extending off from insert 30 as forms an obtuse angle relationship relative to the surface of the insert extending up to form the vertex for that back wall. In addition, each block 78, 80 has a threaded hole extending transversely relative to the aforementioned back walls so as to converge inward toward receiver hitch flange 68 as well as upward in view of the aforementioned upward slope of the bases 78, 80. Received within the thread holes in bases 78, 80 there is received threaded shafts 82, 84 with twisting means 86, 88 as in a hand grip (e.g., a turn knob or wheel or lever extension) for threaded adjustment of the threaded shafts (e.g., bolts). Upon sufficient threading in of bolts 82, 84, contact is made with the portion of the receiver hitch as in outer hitch flange 68. Upon further threading, insert 30 is drawn out such that locking pin aperture edges of insert 30 are compressed against the locking pin, and an enhanced binding (clearance reduction) arrangement is achieved between the received portion of the insert and the receiving portion of the hitch. For example, with the arrangement shown in FIGS. 1I and 1J there is both a drawing out tension force “T” and a binding movement “M” generated so as to provide a stable, anti-wobble arrangement. Base blacks 78, 80 are preferably welded to the surfaces of insert 30 although alternate fixing arrangements (e.g., a bolted or key slot or snapping arrangements) are also featured under the present invention.

FIGS. 2A and 2B illustrate an additional embodiment of the hitch mount stabilizing means 20 of the present invention featuring insert 30 with stabilizer 32, which in the illustrated embodiment, is comprised of an L-shaped bracket 90 having opposite legs 92, 94 mounted to insert 30 by way of mounting blocks 96, 98 which are permanently (e.g., welding or integrated material) or releasably (e.g., threaded bolt) attached to opposite sides 100, 102 of insert 30 as seen by the end view of FIG. 2B. Engagers 104 and 106 are received in threaded apertures formed in bracket 90 such that upon a rotation of twisting means 108, 110 and corresponding engagers (e.g., bolts 104, 106), which are arranged transversely to opposite wall surfaces of hitch 22 (e.g., either flange 68 walls and/or the elongated main body of hitch 22), the engagers draw insert 30 flush up against the applicable hitch receiver corner. Thus, there is avoided wobble inducing clearance spaces. In addition, although not shown, modified tear drop apertures (e.g., with converging portions extending in a Y-axis direction) are also featured under the present invention.

FIGS. 3A and 3B illustrate an alternate embodiments of support unit 20 received by hitch 22 and having insert 30 from which extends off base 112 which preferably has a notch reception area for receiving a corner of insert 30 and is preferably permanently affixed (e.g., welding) thereto. Base 112 is preferably arranged so as to slope in toward flange 68 and has a threaded aperture 114 that has a central axis which places engager 116 (e.g., a threaded shaft with enlarged hand grasping knob 118) in contact with a corner edge the hitch receiver flange 68. Thus, upon sufficient threading of engager 116, insert 30 is drawn out and rotated as to achieve a tensioning effect on the insert relative to the locking pin and also has a surface placed in a fixed abutment relationship with a corresponding interior side surface of the receiver hitch. Thus, a stabilized arrangement is achieved with the single engager engagement device.

FIG. 4A shows a side view of a further embodiment of support unit 20 received by receiver hitch 22 and having insert 30 from which extends (e.g., off an upper surface) handle-shaped base 120 with longitudinally extending leg 122 having a threaded (vertically oriented) aperture, through which extends engager 124. Engager 124 is provided with rotation handle 126, which upon engager engagement with the hitch, generates a moment generation that moves the insert 30 into contact with the interior surface of hitch 22 and which places the locking pin 128 (e.g., a magnetic head locking pin for helping avoid detachment) under compression as the insert is drawn out. As shown in FIG. 4B, the drawing out also causes the multiple contact surfaces 130, 132 of the converging portion of tear drop aperture 135 to contact the exposed surface of locking pin 128. As further shown, central axis 134 extends along the central axis of elongation of hitch 22 or can be adjusted (e.g., 30° from horizontal to match with a resultant summed force component in common with axis 134 as illustrated in FIG. 4B.)

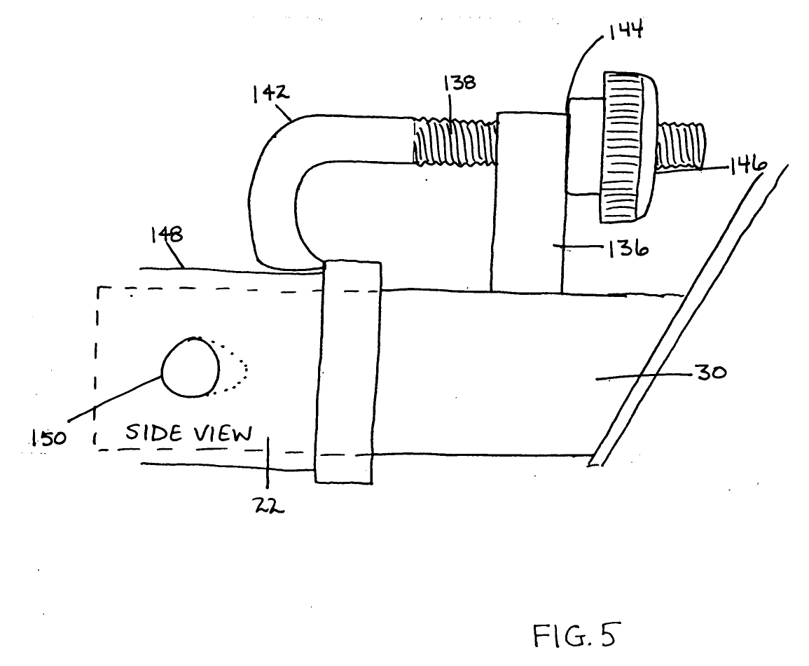

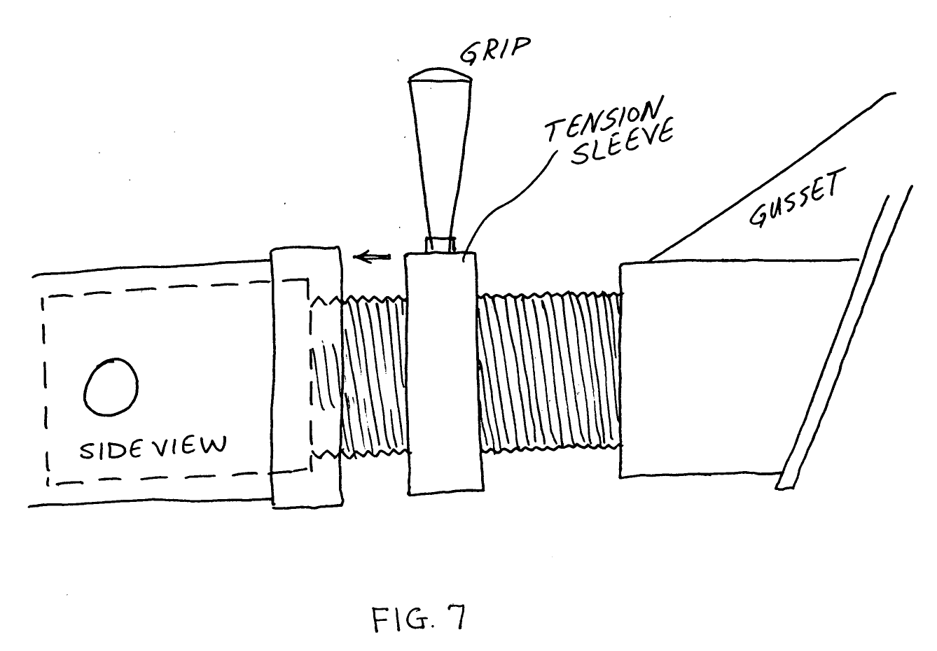

FIGS. 5A and 5B illustrate an alternate embodiment of hitch mount 20 of the present invention having insert 30 received within hitch 22 and having fixed vertical base block 136 having horizontally oriented threaded aperture 138 with engager 140 in the form of a claw or hook device with bent shaft 142 with threaded end 144 and turning knob 146. Upon rotation of knob 146, tip 148 comes into engagement with the vertical edge of flange 68 so as to draw in (as opposed to drawing out as in the earlier embodiments) insert 30. This drawing in creates a compression force on locking pin 150 as multiple contact surfaces 152, 154 are forced into engagement with the converging portion of the tear drop shaped apertures 151.

FIG. 6 shows an alternate embodiment of a stabilizing means which includes a lever engager 152 that is internally pivotally supported within the end of insert 30 by way of an intermediate pivot pin 154. Lever 152 has a contact end 156 that extends through a corresponding slot formed in the upper wall of insert 130 for engagement with the interior surface of the receiver hitch. FIG. 6 further illustrates adjustment device 158 which is threadably supported by threaded block 160 and functions as adjustment means in the lever upon coming into contact therewith.

FIG. 7 shows an alternate embodiment of exercise equipment unit mount 20 received by receiver hitch 22. As illustrated, insert 30 includes main insert body 160 with locking pin apertures 162 designed to generally align with locking pin apertures in hitch 22 (not shown in the partially schematic FIG. 7) and plastic endcap 164 to cover over the hollow or partially hollow main insert body 160. At the opposite end of main insert body then is provided a threaded aperture for receiving a forward end of threaded shaft 166, preferably formed of a rust/corrosion resistant material as in stainless steel. The opposite end of threaded shaft 166 is received within a threaded aperture formed at the forward end of extension sleeve 168 of attachment base.

FIG. 7 further illustrates tensioning cuff 170 having collar 172, glide 175 and twisting means (lever handle) 174, threadably received on the exposed thread area between main insert body 160 (or actually the rear, receiving end of hitch 22) and the forward end of extension sleeve 168. The opposite end 176 of extension sleeve 168 is sloped for attachment to sleeve support plate 178 which is bolstered by way of opposite side and top gussets. Attachment base 24 further comprises tubular sleeve 182 which is designed to receive a tubular, mainframe component of exercise equipment being attached as in the butterfly weight lifting equipment shown in FIG. 1. In association with sleeve 182 there is provided equipment locking pin 184 which is designed to extend through one or a pair of aligned apertures in a portion of the exercise equipment mainframe inserted into sleeve 182. Also, the inserted portion of the exercise equipment preferably has a series of the receiving apertures spaced along the length of the inserted tube to facilitate desired height positioning of the equipment. While the pin and associated apertures are generally formed so as to provide a low wobble tight engagement, additional stabilization means are also featured under the present invention as in a threaded shaft with hand grip received by sleeve 182 and designed to engage the inserted mainframe component of the exercise equipment. Also various other connection means between the exercise equipment (when of the detachable type) are also featured under the present invention as in nut/bolt combinations, key slot attachment, clamps, etc and combinations thereof.

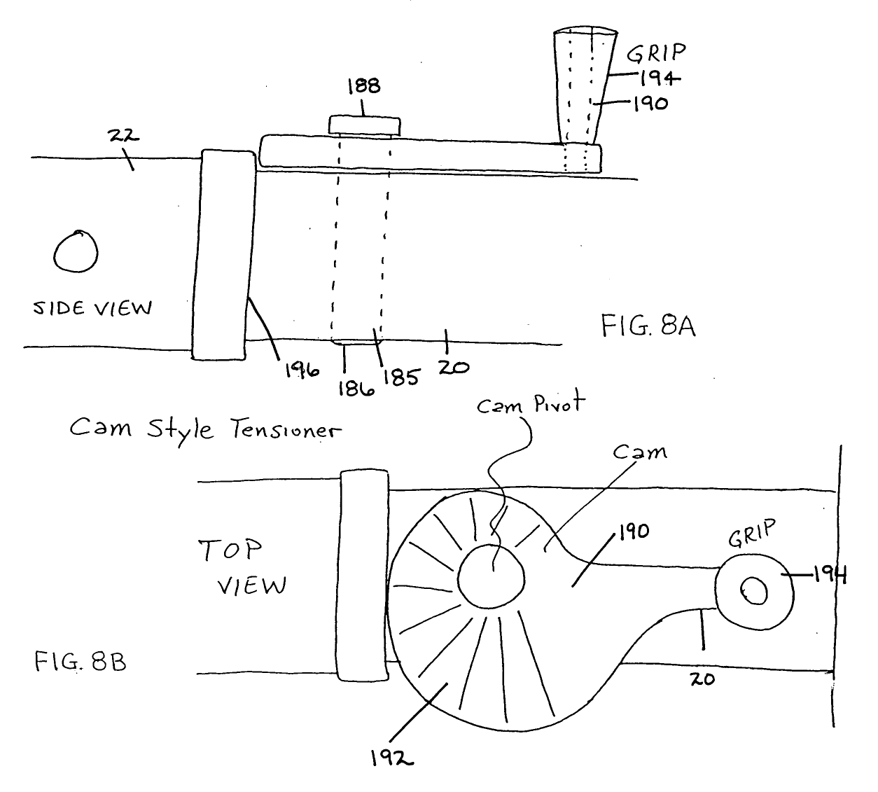

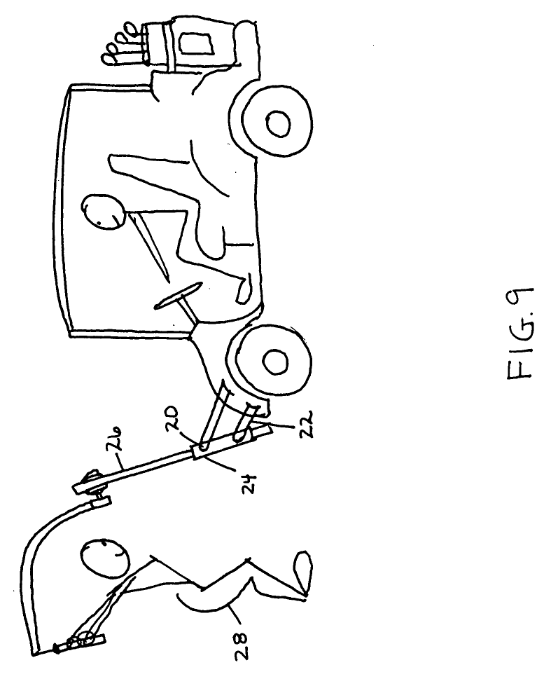

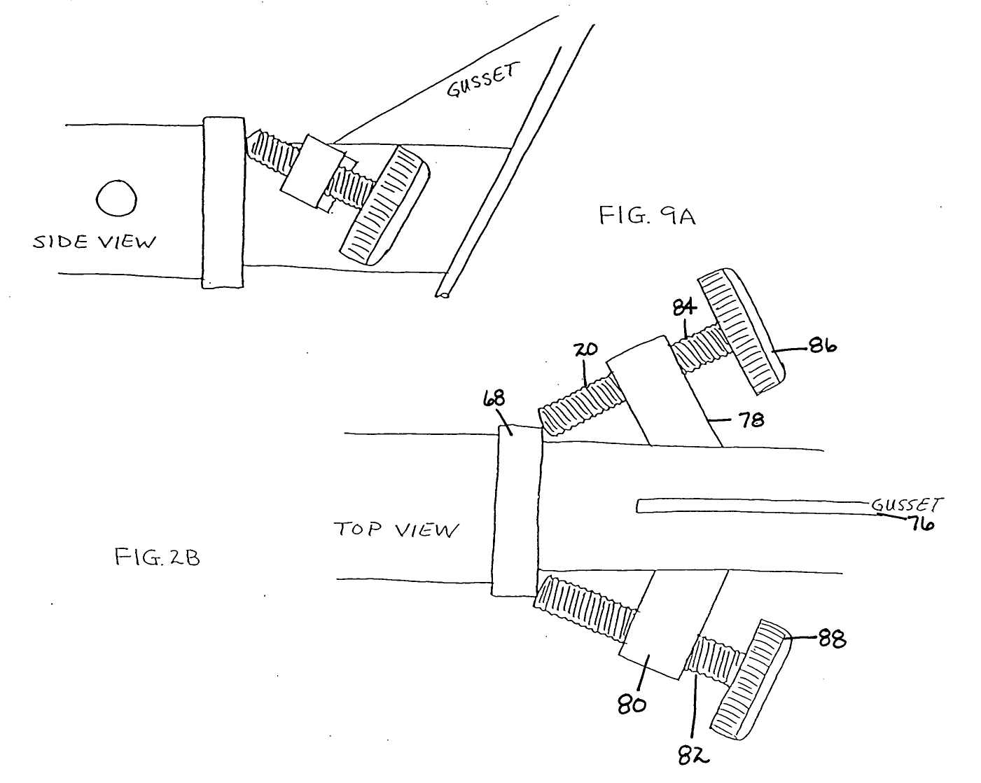

FIGS. 8A and 8B illustrate an additional embodiment of exercise equipment support unit 20 received within receiver hitch 22 and comprising pivot pin 186 extending vertically through aligned holes in the top and bottom walls of insert 30. Pin 186 includes an upper (or lower) clearance section capped off with an enlarged head 188 such that engager 190 is retained but free to pivot about pin 186. Pin 186 is held in place with holding means as in, for example, a threaded end section engagement or end nuts or clips or a spring based bearing, etc.

As shown in FIGS. 8A and 8B, engager 190 includes a cam section 192 and a handle section 194 (preferably L-shaped). Cam section 192 has a contour that is sufficient to come into contact with the receiver hitch facing 196 at various levels of compression as to induce different (settable) levels of tension in the insert 20 which is retained by a locking member (not shown in FIGS. 8A and 8B) received within locking apertures 198 in receiver hitch 22 as well as either circular or non-circular (e.g., the tear drop shape described above) aligned apertures in the insert tubing. Thus, upon rotation of cam engager 190 there is provided a stabilization effect relative to the hitch receiver/insert engagement.

FIG. 9 illustrates exercise equipment support unit 20 being utilized with a golf cart and with user 28 practicing golf swings with a golf swing exerciser 26.

FIG. 9A shows an enlarged view of support unit 20 as well as the sleeve tube 182 which is designed to receive a mainframe component of exerciser 26. FIG. 9A shows also engagement device 198 which comprises a tensioning screw 200 threadably received by base block 202, and is preferably used with a tear shaped aperture 204 in the insert 30.

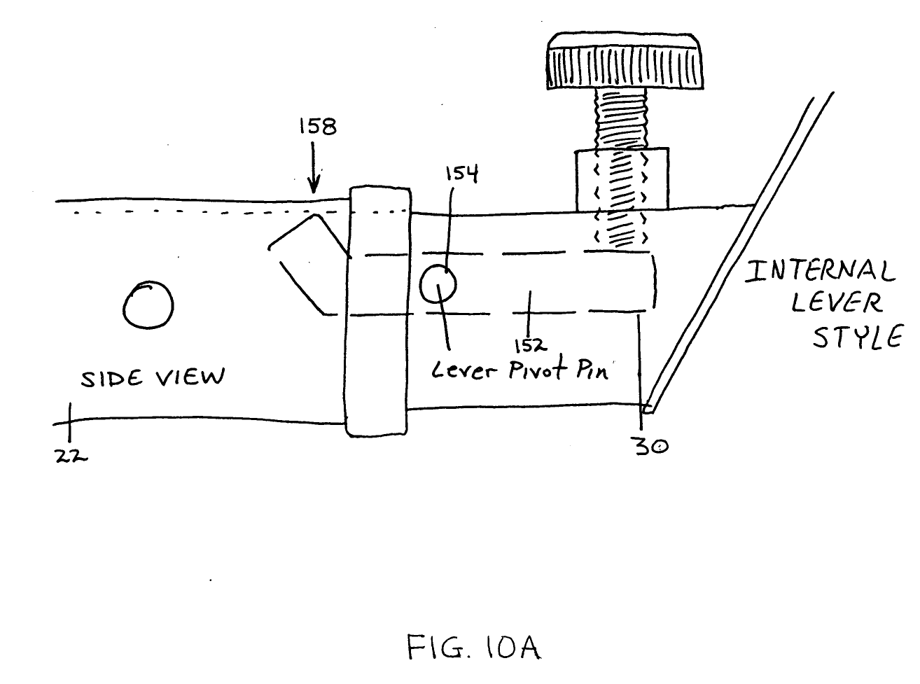

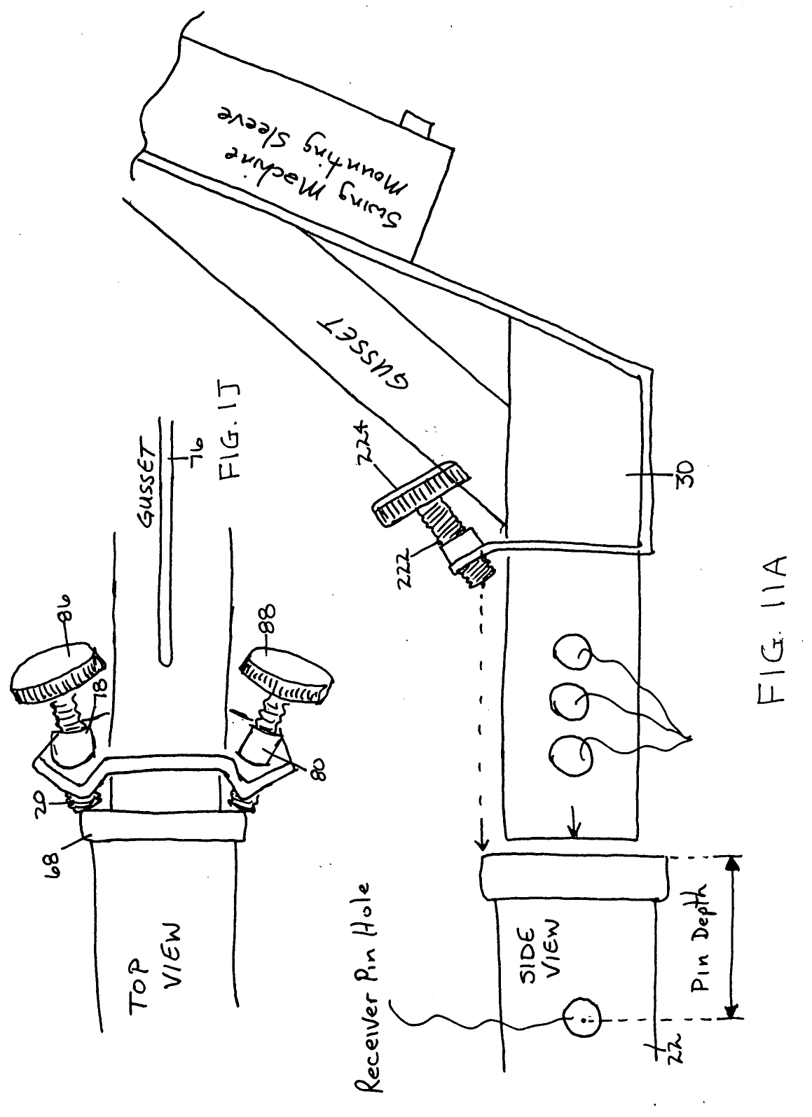

FIGS. 10A and 10D illustrate alternate internal “cam lever” embodiment of the present invention which includes engagement device 206 which comprises engager 208 in the form of a b-shaped cam lever 208 having a receiver hitch contact section 210 with elongated arm 212. Engager 208 is internally positioned within insert 30 and pivotally supported by a hardened and spot welded pivot post 214. Cam lever 208 extends out of a lower slot formed in insert 30 and contacts hitch flange 68 in a bottom region where adjustment device 216 is adjusted. Adjustment device 216 is preferably a screw received within a threaded aperture in the top wall of insert 30 and designed to push down on the free end of the cam lever internally within insert 30. This action thus creates both a lifting and tensioning force on insert 30 within hitch 22 so as to stabilize the insert within the hitch. Adjustment device 216 preferably a screw having an enlarged hand grasping turning knob as in one at least three times the diameter of the screw shaft. FIG. 10C shows a partially cut away view of engagement device 206 take along the cross-section line X-Y in FIG. 10B.

FIG. 10D shows a similar “cam lever” embodiment as that in FIGS. 10A-10C but without an adjustment device and with the hand manipulation of lever 218 providing for the over center shaped bulbous end 220 to lock in tension generating place. The engager 215 can be internally placed as shown or space to one or both sides (e.g., a bridle shaped or U-shaped lever arrangement) extending the opposite side walls of insert 30.

FIGS. 11A and 11B illustrate an additional embodiment of the support unit 20 of the present invention which includes engager in the form of an elongated threaded bolt with enlarged head 224 (preferably finger grasping end). As shown in FIG. 11B engager 222 extends within threaded aperture 226 formed in the top wall of insert 30 and down through a slot 223 formed in the bottom wall of insert 30 so as to generate a stabilizing, clearance reduction effect.

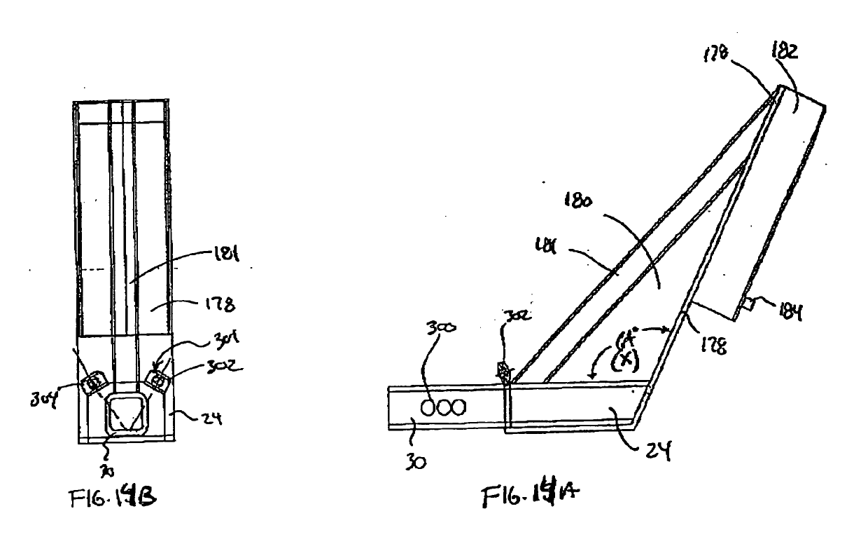

FIG. 12 shows an embodiment similar to FIG. 4A of the support unit 20 with handle shaped base, but with its handle shaped base 228 secured (e.g., weld) at common edge 230 with sloped gusset 232 forming part of attachment base 24. FIG. 12 further illustrates a preferred meg-lock locking pin 234 with magnetized head 236 to avoid detachment. FIG. 12 further illustrates threaded engager 230 received by base 228 and having a softer (e.g., small cell foam plastic material) as twisting means 240.

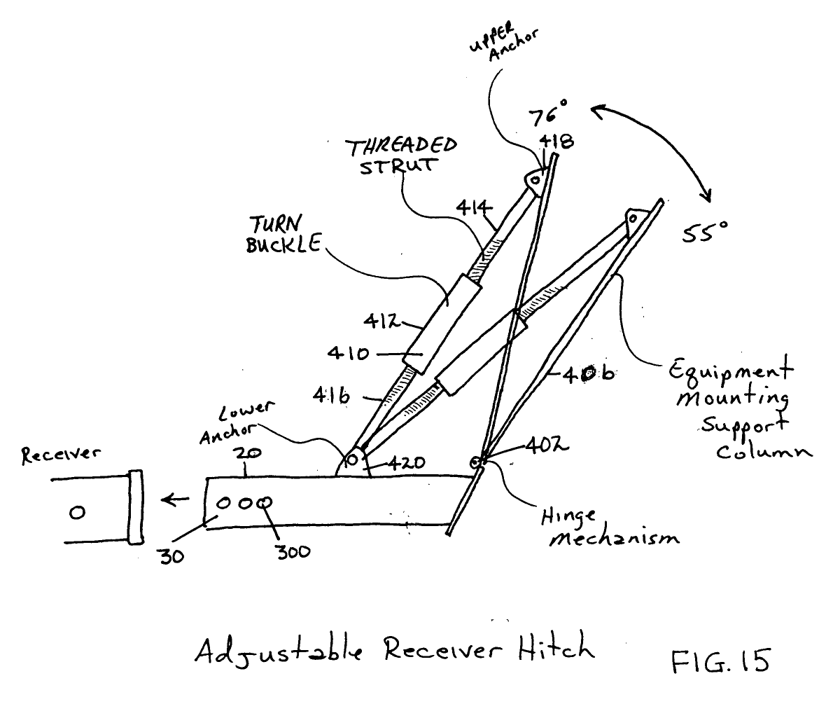

FIGS. 13A and 13B show an alternate engager 244 which is bridle shaped and utilized relative to an alternate telescoping arrangement wherein the insert has a periphery greater than that of a tubular receiver hitch. As shown in FIGS. 13A and 13B, insert 30 slides over the smaller receiver tube for pin locking and further includes an engager which is bridle or U-shaped having a very high coefficient spring section 248 designed for temporary retainment in minor capture recess 250 formed in insert 230. Thus, upon downward rotation of handles 252 (one or two), the deflection section 248 forces insert 30 to lift up and become in surface-to-surface stabilized contact—a tear drop insert aperture (outer holes in this case are preferably included as well).

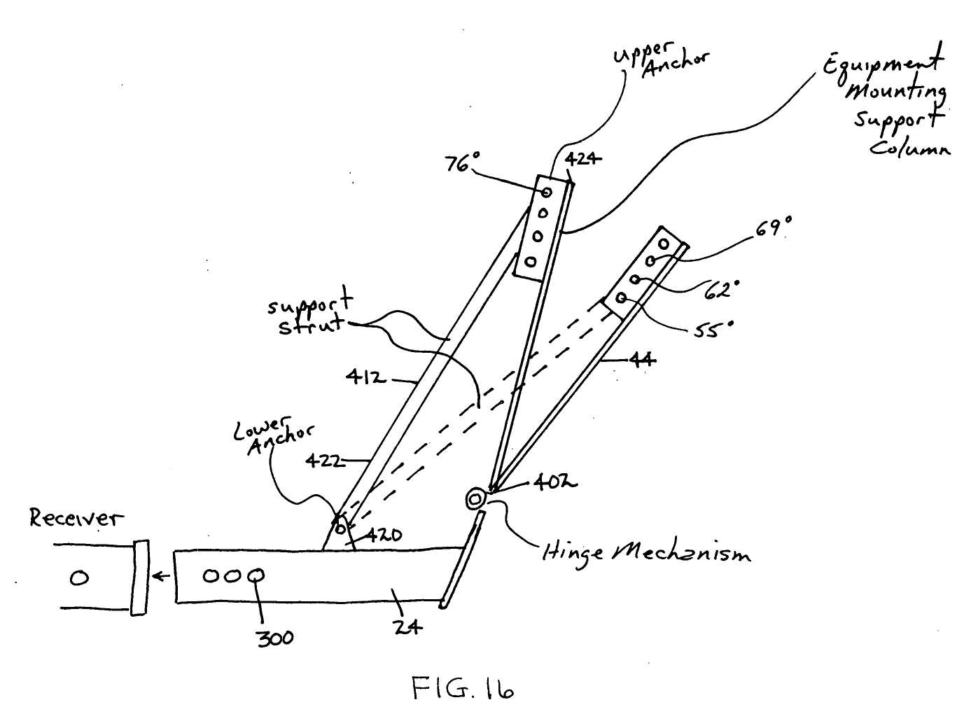

FIGS. 14A and 14B illustrate an additional embodiment of the invention comprising insert 30 and attachment base 24. As shown, insert 30 includes multiple locking pin receptor holes with three illustrated to enhance the universal nature of the present invention relative to a variety of hitch types. Attachment base is also represented as an enlarged high strength tubular member which is secured (e.g., welded) to the insert 30. At the edge of attachment base 24 there is engagement device 301 comprising threaded base supports (302, 304) and with the threaded engagers not shown for draftsperson convenience. Attachment base 24 includes gusset 180 with strengthening support rib 181 and support plate 178 to which tubular sleeve 182 is welded or otherwise fixed. Exerciser engagement pin 184 is also shown. The gusset 180 angle is at angle X (e.g., 60-70° as in 64°.)

FIG. 15 illustrates an additional embodiment of the invention featuring a swing plane adjustable exercise equipment attachment base. The illustrated support unit 20 in FIG. 15 comprises insert 30 having multiple locking pin holes 300 and stabilizing means 32. Attachment base 24 features insert receiving sleeve or exercise equipment attachment means 400 having precision hinge section 402 with slope angle indicator 404 (e.g., of a protractor configuration.) Pivotally joined at precision hinge 402 is equipment support plate 406 which preferably supports an exercise equipment attachment means as in the aforementioned tubular sleeves or is an integral component of an exercise equipment component. FIG. 15 further illustrates angle adjustment means 408 which in the illustrated embodiment includes turn-buckle 410 having adjustment sleeve 412 and upper and lower threaded rods 414, 416. Upper rod 414 is pivotally attached to plate anchor 418 while lower rod 416 is pivotally attached to lower anchor 420. As seen from FIG. 15, the adjustment means provides for angle adjustment of the exercise equipment attachment plate or component as in a 55° to 80° swing potential.

FIG. 16 illustrates an additional swing plane adjustable trailer hitch, base wherein the swing plane adjustment means 412 comprises a similar lower anchor 420 as before, but a lever 422 and multiple aperture upper support anchor 424. Lever 422 is shown in greater detail in FIG. 16A and features a unitary high strength rod (e.g., steel) with fixed (tight tolerance) pin holes at each end for receipt of a magna-look pivot pin, for example. The multitude of holes in the upper anchor 424 provides for various settings as in 7° angle step variations (e.g., 55°, 62°, 69°, 76°). The above two described swing plane adjustable embodiment of the present invention are suitable for use with or without stabilization means (and thus FIG. 16 provides an illustration free of stabilizer means), but a preferred usage is in association with stabilizing means 32 as shown in FIG. 15.

The present inventive mount renders exercise equipment as stable and secure as the vehicle it is attached to. The secure attachment to a vehicle allows fitness equipment to be made minimally and more compact due to the fact that equipment so mounted does not produce a topple-over risk.

The hitch mount of the present invention is desirable because it eliminates the need for wide leg spacings to stabilize equipment and also eliminates the need for the equipment to contact the ground or other surface at all. Due to the inherent strength of the receiver hitch and the weight of the vehicle the present invention can support more weight with less visible support means.

One embodiment of this invention can support a golf swing strengthening device whereby the hitch mount provides 100% of the support and stabilization of said strengthening device. No struts, downriggers, legs or braces are required as a mounting means which would otherwise be heavy and hard to transport. The present invention can be quite small and lightweight.

This inventive device and concept is unique and is the only support means designed to encompass a receiver hitch, the vehicle weight, and a 4-point stability of the vehicle to be used exclusively while the vehicle is in a stationary position.

The present inventive device is designed to support and stabilize various fitness/exercise equipment so that the weight and stability of a vehicle provides substantial and adequate anchorage of the fitness equipment so that it may be used by individuals in a variety of indoor and outdoor locations where the anchor vehicle may be parked and stationary. By utilizing a vehicle as the support means, the fitness equipment can be made lighter and more compact which is desirable for shipping, transport, mounting, attachment, and use.

What is claimed is:

1. An exercise equipment support unit for attachment to a vehicle receiver hitch comprising:
(i) a mount shank receivable in an end of the receiver tube of a receiver hitch;
(ii) a device on said mount shank for applying tension or force between said mount shank and said receiver tube; and
(iii) means for applying a force to said mount shank and said receiver hitch beyond said end of said receiver tube, whereby movement of said mount shank within said receiver tube is prevented.

2. The support unit of claim 1, wherein said means for applying a force to said mount shank is selected from the group consisting of a bolt, a collar, a screw, a moveable flange, a knob, a wing nut, and the like.

3. A support system for attaching an exercise apparatus to a vehicle, comprising:
(i) support having first and second ends, with the first end of said support being configured for attachment to the vehicle such that said support extends generally horizontally from said vehicle;
(ii) a member connected toward the second end of and extending upwardly from said support; and
(iii) an apparatus supported toward a free end of said member to facilitate attachment of an exercise apparatus thereto, with said apparatus extending upwardly from and at an angle ranging between about 30° and about 90° relative to said support, said apparatus including a mounting mechanism configured to permit attachment of the exercise apparatus thereto.

4. The support system according to claim 3 wherein said support includes first and second parts arranged in telescopic relation relative to each other whereby allowing the exercise apparatus to be positioned at different distances from the vehicle.

5. The support system according to claim 4 wherein said support further includes an attachment mechanism for releasably attaching said first and second parts in a variety of selected linear positions relative to each other to effect the operative length of said support.

6. The support system according to claim 3 wherein said member is fixedly attached to and extends from said support.

7. A support system for releasably mounting exercise equipment to a receiver hitch mounted on a rear end of a vehicle, said support system comprising:
(i) a support defining an elongated axis between inner and outer ends, with the inner end of said support being configured for releasable attachment to the receiver hitch on the vehicle such that said support extends generally horizontally from the vehicle;
(ii) a member arranged toward the outer end of and extending upwardly and away from said support, and wherein an axis of said member and the elongated axis of said support define an included angle ranging between about 30° and about 90° therebetween; and
(iii) an exercise mounting apparatus arranged toward a free upper end of said member to permit selective positioning of exercise equipment thereon.

8. The support system according to claim 7 wherein said support includes first and second elongated pieces arranged in telescopic relation relative to each other.

9. The support system according to claim 8 wherein said support further includes an attachment mechanism for releasably attaching the first and second pieces of said support in a variety of selected linear positions relative to each other to effect the operative length of said support.

10. The support system according to claim 8 wherein the first piece of said support has a free end selectively attachable to the receiver hitch on said vehicle.

11. The support system according to claim 7 wherein said exercise mounting apparatus and said member are adjustably interconnected to each other whereby allowing said exercise mounting apparatus to be vertically adjustable relative to said support.

12. A support system for releasably mounting exercise equipment to a receiver hitch mounted on a rear end of a vehicle, said support system comprising:
(i) a support defining an axis between inner and outer ends, with the inner end of said support being configured for releasable attachment to the receiver hitch on the vehicle such that said support extends generally horizontally from the vehicle;
(ii) a member defining an elongated axis, with said member being arranged toward the outer end of and extending upwardly and away from said support, and wherein the elongated axis of said member and the axis of said support defining an included angle ranging between 30° and about 90° therebetween; and
(iii) an exercise equipment mounting apparatus adjustably securable toward a free upper end of said member, said exercise equipment mounting apparatus being both pivotal about and movable along the elongated axis of said member with said exercise equipment mounting apparatus further including a mounting mechanism which is adjustable about an axis extending generally traverse to said member to further facilitate leveling of said exercise equipment.

13. The support system according to claim 12 wherein said support includes first and second elongated pieces arranged in telescopic relation relative to each other.

14. The support system according to claim 13 wherein said support further includes an attachment mechanism for releasably attaching the first and second pieces of said support in a variety of selected linear positions relative to each other to effect the operative length of said support.

15. A support unit for attachment to a vehicle receiver hitch, comprising:
(i) an insert for assuming a telescoping relationship along a longitudinal axis of the receiver hitch;
(ii) an attachment base supported by said insert;
(iii) a locking member which locks said insert from longitudinal release from the telescoping arrangement; and
(iv) stabilizing means for limiting wobble potential between said insert and the receiver hitch.

16. The support unit of claim 15 wherein said attachment base includes exercise equipment attachment means.

17. The support unit of claim 16 wherein said exercise equipment attachment means includes a sleeve for receiving a component of exercise equipment.

18. The support unit of claim 16 wherein said attachment base includes a swing member and a swing angle adjuster.

19. The support unit of claim 18 wherein said swing member includes attachment means for attaching a component of an exercise device.

20. The support unit of claim 15 wherein said stabilizer means includes means for adjusting a contact relationship between said insert and receiver hitch and retaining that contact level until release of said stabilizing means.

21. The support unit of claim 20 wherein said stabilizer means functions to place and retain a surface of the insert in flush contact with the receiver hitch.

22. The support unit of claim 21 wherein said stabilizing means further produces and retains a tensioning or compression force on the insert relative to the locking member.

23. The support unit of claim 20 wherein said stabilizer means functions to tilt said insert within the receiver hitch and retain a resultant contact relationship.

24. The support unit of claim 23 wherein said stabilizing means further produces and retains a tensioning or compression force on the insert relative to the locking member.

25. The support unit of claim 20 wherein said stabilizing means produces and retains a tensioning or compression force on the insert relative to the locking member.

26. The support unit of claim 25 wherein said insert has locking member reception apertures that are non-circular.

27. A method of assembling an exercise equipment support unit for attachment to a vehicle receiver hitch, including:
(i) providing an insert designed for assuming a telescoping relationship with the receiver hitch;
(ii) providing an attachment base for supporting exercise equipment;
(iii) providing a locking member for precluding complete telescope release between the receiver hitch and insert; and
(iv) providing stabilizing means for reducing a level of freedom of play in movement between the telescoping insert and receiver hitch.

28. An exercise equipment mount, for attachment to a receiver hitch, comprising:
(i) an insert dimensioned for assuming a telescoping relationship with the receiver hitch;
(ii) an attachment base which supports exercise equipment in use and is connected to or integrated with said insert;
(iii) a locking member which is received by the insert and receiver hitch to prevent full telescopic release of said insert from the receiver hitch; and
(iv) a stabilizer, which includes an engager that is adjustable from a first position to a second position with the second position preventing to a greater extent freedom of relative movement between said insert and the receiver hitch.

29. The mount of claim 28 further comprising an exerciser attachment means supported by said insert.

30. The mount of claim 29 further comprising exerciser equipment supported by said attachment base.

31. The mount of claim 28 wherein said adjustment base includes means for swing adjustment of said base relative to said insert.

32. The mount of claim 28 wherein said locking member is a locking pin and said insert includes a tear shaped locking pin reception aperture.

33. An insert for use with a hitch mount, comprising a multi-sided tubular member with a pair of aligned tear drop shaped locking pin reception apertures.
